(19) United States
(12) Patent Application Publication
(10) Pub. No.: US 2024/0408945 A1
(43) Pub. Date: Dec. 12, 2024

(54) ARRANGEMENT FOR MOVING A COVER FOR A VEHICLE ROOF, AND VEHICLE ROOF

(71) Applicant: Webasto SE, Stockdorf (DE)

(72) Inventors: Sebastian GERING, Stockdorf (DE); Kilian WALCHER, Stockdorf (DE); Christian KNOP, Stockdorf (DE)

(21) Appl. No.: 18/733,479

(22) Filed: Jun. 4, 2024

(30) Foreign Application Priority Data
Jun. 7, 2023 (DE) 102023114941.5

(51) Int. Cl. B60J 7/043; B60J 7/057

(52) U.S. Cl. CPC B60J 7/0435; B60J 7/0573

(57) ABSTRACT

An arrangement for moving a cover for a vehicle roof which has a roof opening. The opening-out mechanism has a guide rail, which extends longitudinally along a longitudinal direction (X), and a carriage, which can be displaced along the longitudinal direction (X) in the guide rail, wherein the carriage is coupled to the cover for the purpose of moving the latter. The opening-out mechanism has a movable control lever for controlling the movement of the cover. As seen in relation to a transverse direction (Y), which runs transversely to the longitudinal direction (X), the movable control lever is supported on the carriage and the guide rail such that it is guided both in a displaceable manner on the carriage and in a displaceable manner on the guide rail.

### CROSS-REFERENCE TO RELATED APPLICATION(S)

This application claims the benefit of German patent application no. 10 2023 114 941.5 filed on Jun. 7, 2023, which is incorporated herein by reference in its entirety.

### TECHNICAL FIELD

The disclosure relates to an arrangement for moving a cover for a vehicle roof. Also specified is a vehicle roof having such an arrangement.

### BACKGROUND

Arrangements of the type in question for a vehicle roof are widely known and serve so that, for opening purposes-starting from a closed position for closing a roof opening—an opening-out mechanism can be used first of all to raise a cover in its rear region and then to displace it rearwards into an open position. DE 10023314 C1 describes, in this respect, for example a so-called externally guided sliding roof.

### SUMMARY

It is an object of the invention to specify an arrangement for moving a cover for a vehicle roof, and also a vehicle roof, which provide for reliable operation.

According to a first aspect, the invention discloses an arrangement for moving a cover for a vehicle roof which has a roof opening. For opening purposes—starting from a closed position, in which the cover closes the roof opening—an opening-out mechanism can be used to open out the cover, in the region of its rear edge, into a ventilation position and then to bring it into an open position. The opening-out mechanism has a guide rail, which extends longitudinally along a longitudinal direction X. The opening-out mechanism has a carriage, which can be displaced along the longitudinal direction X in the guide rail, wherein the carriage is coupled to the cover for the purpose of moving the latter. The opening-out mechanism has a movable control lever for controlling the movement of the cover. As seen in relation to a transverse direction Y, which runs transversely to the longitudinal direction X, the movable control lever is supported on the carriage and the guide rail such that it is guided both in a displaceable manner on the carriage and in a displaceable manner on the guide rail.

The control lever is, for example, a front or rear opening-out lever, preferably a control rod, a locking lever or a locking rod. The control lever is designed to be movable, that is to say pivotable and/or displaceable, relative to the guide rail, which can be considered as being fixed in position.

The invention makes provision for the control lever to be supported on both sides, that is to say on opposite sides, as seen in relation to the transverse direction Y. It is therefore guided mechanically between the guide rail and the carriage, even during relative movements between the control lever and the guide rail and/or the carriage. The lateral support makes it possible for the control lever to be of slender design in particular in the region in which the two-sided support is provided. A slender design, for example a comparatively thin-walled, narrow, flat design or the like, allows considerable savings to be made in terms of installation space. The lateral support ensures that, despite the slender design of the control lever, the latter nevertheless withstands the loads which are in effect during operation. In particular, this helps prevent buckling of the control lever, for example in the presence of so-called block loads. In other words, the support is constituted by a supporting structure or supporting geometry for the control lever.

The carriage is, in particular, a drive carriage. The carriage is displaced forwards or rearwards along the longitudinal direction X, in order to bring about the aforementioned movement of the cover from the closed position into a fully open position.

The control lever is, in particular, in direct contact with the guide rail and the carriage for the support.

According to at least one further embodiment, as seen in relation to the transverse direction, the control lever is guided in a form-fitting manner between the guide rail and the carriage. The form fit is such that in each case sliding is possible between the control lever and guide rail or control lever and carriage. However, the form fit is not of such a nature as to constitute a kind of press fit or to give rise to excessive play, which could lead for example to rattling and therefore to undesirable noise production. The best thing would be to describe the form fit as a coupling akin to a transition fit. In other words: Tolerance compensation is realized by a “soft” mounting of the (entire) mechanism in the rail. The mechanism, i.e. for example the control lever and/or carriage, slides for example on soft sliders with rubber inserts.

According to at least one further embodiment, in each movement phase of the cover, the control lever is supported both on the guide rail and on the carriage. This therefore ensures, in each operating phase, the aforementioned support and the associated advantages and functions.

According to at least one further embodiment, on a first side, which is directed towards the carriage, the control lever has one or more sliding surfaces for guiding on the carriage. In addition, on a second side, which is directed towards the guide rail, the control lever has one or more sliding surfaces for guiding on the guide rail. This results in the formation of sliding friction between the control lever/guide rail or control lever/carriage contact partners. This makes the aforementioned advantages and functions possible.

According to at least one further embodiment, at least one sliding surface has one or more recesses. For example, build-ups of material are prevented as a result. It is optionally possible to use such recesses as grease reservoirs, so that the appropriate sliding regions are lubricated.

According to at least one further embodiment, in the region of a rear end of the control lever, the control lever is supported on the carriage and the guide rail. This means that the control lever is not correspondingly supported over its entire length or extent, which is possible, in particular, when the control lever is otherwise mounted at its other, front end. It is not imperative for sliding surfaces or contact surfaces in relation to the guide rail and/or the carriage to be formed in particular in a central portion of the control lever. This makes a cost-effective configuration possible. In addition, away from this region of the rear end, the control lever can be freely configured. It is noted here that the rear end and front end of the control lever are also to be understood as the upper or lower end or, in general terms, as the first and second end.

According to at least one further embodiment, the control lever has a supporting structure, which is provided with a plastic over-moulding for support on the carriage and on the guide rail. In particular, the supporting structure is a metallic element, for example a steel component. For example, the control lever is designed in principle in the form of a metal component, for example a steel component, the plastic over-moulding being provided in the rear region. For example, in the region of the two-sided support, the control lever is designed in the form of a plastic component with a steel insert. On account of the material pairings between the plastic over-moulding and carriage (typically made of metal) and/or guide rail (typically made of metal), this makes particularly good sliding properties possible. It also helps to keep development of noise to a particularly low level. In contrast, the carriage is, for example, a plastic component.

According to at least one further embodiment, the control lever is designed in the form of a control rod and is coupled to the carriage for the purpose of controlling the cover. This results in the movement of the carriage being transmitted to the cover indirectly via the control rod. The aforementioned advantages and functions are particularly evident precisely when the control lever is designed in the form of a control rod.

According to at least one further embodiment, the guide rail has a guide path for guiding the carriage and the control lever. The carriage has, for example, a control slider for guiding purposes in the guide rail. The control lever likewise has a control slider. The guide path is, for example, a common guide path for the carriage and the control lever, in particular in a movement phase of the cover during which the carriage and control lever are arrested in relation to one another and are moved together in the longitudinal direction X.

According to at least one further embodiment, the carriage has a control track and the control lever has a protrusion, by means of which the control lever is in engagement with the control track. The control track is designed such that, in the closed position of the cover, there is free relative movement between the control lever and carriage in the longitudinal direction, whereas-starting from the closed position of the cover-when the carriage is displaced along the longitudinal direction, the protrusion can be brought into engagement with the control track such that relative movement between the control lever and the carriage is arrested.

In particular, the control lever and carriage are constantly in engagement via the track, wherein, depending on the profile of the track, the movement between the control lever and carriage is arrested and freed. In particular in the open position of the cover, relative movement between the control lever and carriage is arrested, so that displacement of the carriage displaces the cover in the longitudinal direction X. It is thus possible in the first instance to set the ventilation position of the cover, in which the control lever does not move the cover in the longitudinal direction X. As movement progresses, the cover can then be moved in the longitudinal direction X when the control lever and carriage have been arrested in relation to one another in the longitudinal direction X.

According to at least one further embodiment, the guide rail has a fixed-position locking track for the control lever, wherein the control lever has a control slider for engaging in the locking track. The locking track is designed such that, in the closed position of the cover, the control lever is located in a locking position, so that movement of the cover along the longitudinal direction X is blocked. Starting from the closed position, when the carriage is displaced along the longitudinal direction X, the control lever can be directed, by means of the rear opening-out lever, out of the locking position into an unlocking position, so as to free movement of the cover along the longitudinal direction.

The control slider and the protrusion are arranged, in particular, at the rear (first) end of the control lever, as described above. Furthermore, the control slider and the protrusion are arranged so as to be directed away from one another, in particular on opposite sides of the control lever, as seen in relation to the transverse direction Y.

The locking track is fixed in position and has a profile which is made up of essentially two portions. A first portion runs obliquely in relation to the longitudinal direction X or perpendicularly, that is to say in the vertical direction or Z direction. If the control slider is located in this first portion (in particular at the end of the profile portion), then the control slider is located in the locking position. Displacement of the carriage transfers the control slider out of the first portion into a second portion, which runs essentially horizontal in the longitudinal direction X. The second portion can be the aforementioned guide path or can merge seamlessly into the same. The movement of the control lever in the longitudinal direction X is then freed, the control lever in this case being fixed to the carriage, so that the control lever is carried along by the carriage in the longitudinal direction X.

The locking track, as part of the guide rail, serves as a sliding partner for the control lever, that is to say for the support of the latter, in particular for the control slider. During the opening operation of the cover-starting from the closed position-first of all the control lever is supported on the control track, that is to say on the walls thereof, before it is then supported on the guide rail in the region of the aforementioned guide path for the carriage or the control lever.

According to at least one further embodiment, the arrangement has a front opening-out lever and a rear opening-out lever, wherein the rear opening-out lever is in engagement with the carriage, so that, when the carriage is being displaced, it is possible to control an opening-out movement of the cover into the ventilation position, and wherein the control lever is coupled both to the front opening-out lever and to the carriage.

According to a second aspect, the invention discloses a vehicle roof for a vehicle, having an arrangement according to one of the embodiments above.

Further advantages, features and developments can be gathered from the following examples explained in conjunction with the figures. Like, similar and identically acting elements can be provided with like reference signs throughout the figures.

### BRIEF DESCRIPTION OF DRAWINGS

FIG. 1 shows a schematic illustration of a vehicle according to one exemplary embodiment,

FIGS. 2 to 4 show schematic illustrations of various operating states of an opening-out mechanism according to one exemplary embodiment, and

FIGS. 5 to 16 show schematic illustrations of various detail-specific views of the opening-out mechanism according to the exemplary embodiment.

### DETAILED DESCRIPTION

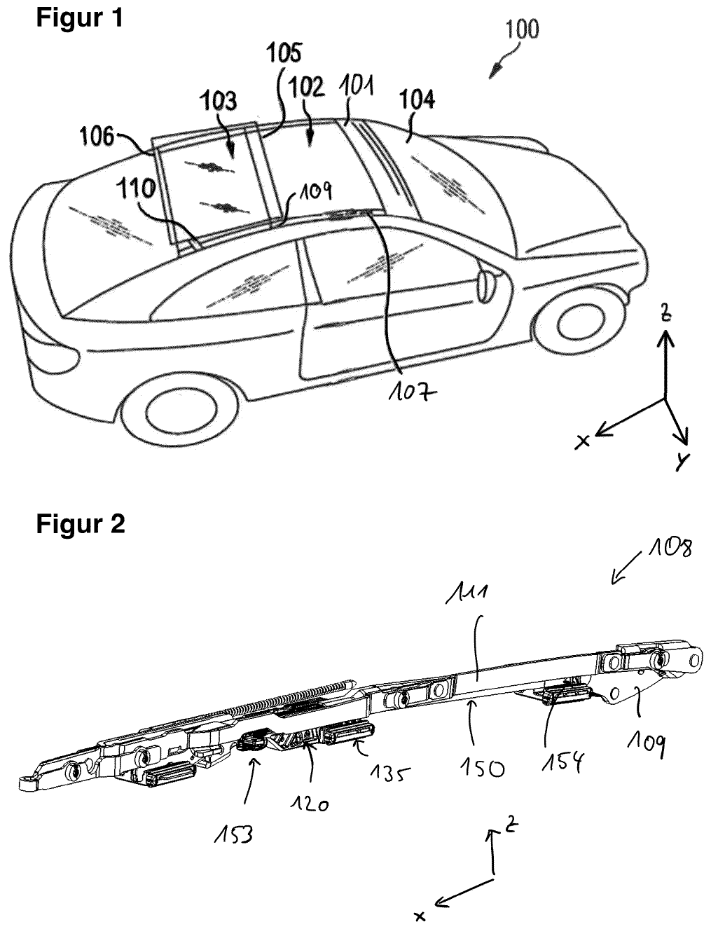

FIG. 1 shows a vehicle 100, in particular a motor vehicle, according to one exemplary embodiment. The vehicle 100 has a vehicle roof 101. A cover 103 is arranged on the vehicle roof 101. The cover 103 is movable for example relative to the rest of the vehicle roof 101. It is therefore possible for a roof opening 102 to be either closed or partially exposed by the cover 103.

The vehicle has a windscreen 104. The cover 103 has a front edge 105, which in the operational state is directed towards the windscreen 104. A rear edge 106 of the cover 103 is directed away from the windscreen 104, as seen in relation to a longitudinal direction X.

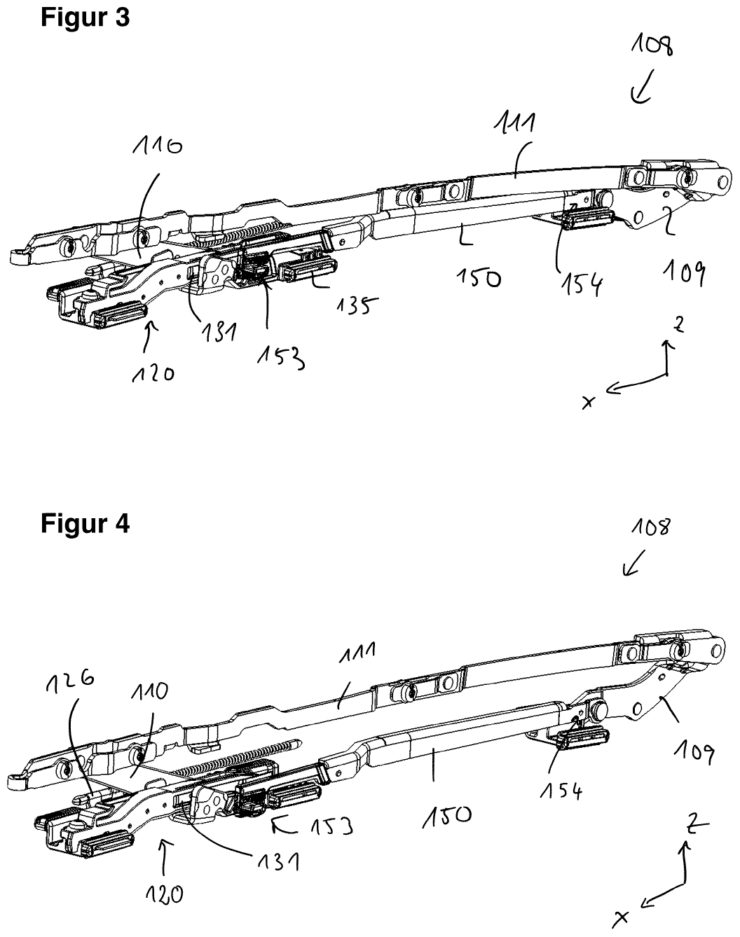

The movement of the cover 103 is realized by an opening-out mechanism 108 (FIGS. 2 and 3). The opening-out mechanism 108 has for example a guide rail 107, which is connected to the vehicle roof 101. For example a drive cable is guided in the guide rail 107. The drive cable is for example in contact with an electric drive motor and further components of the opening-out mechanism 108, in order to move the cover 103 relative to the rest of the vehicle roof 101.

For example, the opening-out mechanism 108 is designed in the manner of a so-called externally guided sliding roof. During operation, a rear opening-out lever 110, which is assigned to the rear edge 106, is displaced together with the cover 103, relative to the rest of the vehicle roof, in the opening direction. This can be different for example in the case of so-called spoiler roofs, in which, for opening purposes, the cover is displaced relative to the rear opening-out lever.

Information given in relation to location or direction, such as rearwards or forwards, upwards or downwards, left or right, vertical (ly) or horizontal (ly), refers to a longitudinal vehicle axis and a customary direction of travel of an operational vehicle 100. The longitudinal vehicle axis is a horizontal axis and can be referred to as the X axis or longitudinal direction X. The transverse vehicle axis is also a horizontal axis and can be referred to as the Y axis or transverse direction Y. The vertical vehicle axis runs vertically and can also be referred to as the Z axis or vertical direction Z. The vertical direction Z, the transverse direction Y and the longitudinal direction X form a Cartesian coordinate system and are each oriented perpendicularly in relation to one another, as depicted in FIG. 1.

The opening-out mechanism 108 is arranged in particular on both sides of the roof opening 102, the two mechanisms being of the same kind. The following text will therefore describe just one side and the description, the features, functions and advantages also apply correspondingly to the opposite side.

FIGS. 2 to 4 show the opening-out mechanism 108 according to one exemplary embodiment. FIG. 2 shows the opening-out mechanism 108 in a closed position of the cover 103. FIG. 3 shows the opening-out mechanism 108 in a position in which the cover 103 has been opened out in the Z direction at the rear edge 106 (ventilation position), but not displaced in the X direction. FIG. 4 shows the opening-out mechanism 108 in an open position of the cover 103. It is noted here that the cover 103 is not shown in FIGS. 2 to 4. However, these figures do show a cover support 111, which is fixed to the cover 103 for the purpose of moving the same. The movement of the cover support 111 corresponds to the movement of the cover 103.

The opening-out mechanism 108 has a front opening-out lever 109. During operation, the front opening-out lever 109 is arranged on the front edge 105 of the cover 103. During operation, the rear opening-out lever 110 is arranged on the rear edge 106 of the cover 103. The rear edge 106 can be raised and lowered along the vertical direction Z by means of the rear opening-out lever 110. The front edge 105 of the cover 103 can be raised and lowered by means of the front opening-out lever 109. In addition, the cover 103 can be displaced along the longitudinal direction X by means of the two opening-out levers 109 and 110.

The front opening-out lever 109 is coupled to the rear opening-out lever 110 by means of a control rod 150, which in the context of this application corresponds to the control lever.

The control rod 150 extends longitudinally along the X direction. At a front end 154, the control rod is connected in a pivotable manner to the front opening-out lever 109, so that the front opening-out lever 109 can be rotated relative to the control rod 150.

At a rear end 153, the control rod 150 is connected to a carriage 120. The carriage 120, in turn, is coupled to the rear opening-out lever 110. The rear opening-out lever 110 and the control rod 150 are therefore connected to one another indirectly by means of the carriage 120.

The carriage 120 is retained, and guided in a displaceable manner, in the guide rail 107. The carriage 120 is displaceable relative to the guide rail 107 along the longitudinal direction X, in order to drive the movement of the cover 103. The carriage 120 can therefore also be referred to as a drive carriage. The carriage 120 is arranged in particular on the rear edge 106 of the cover 103 or in a rear region of the cover 103.

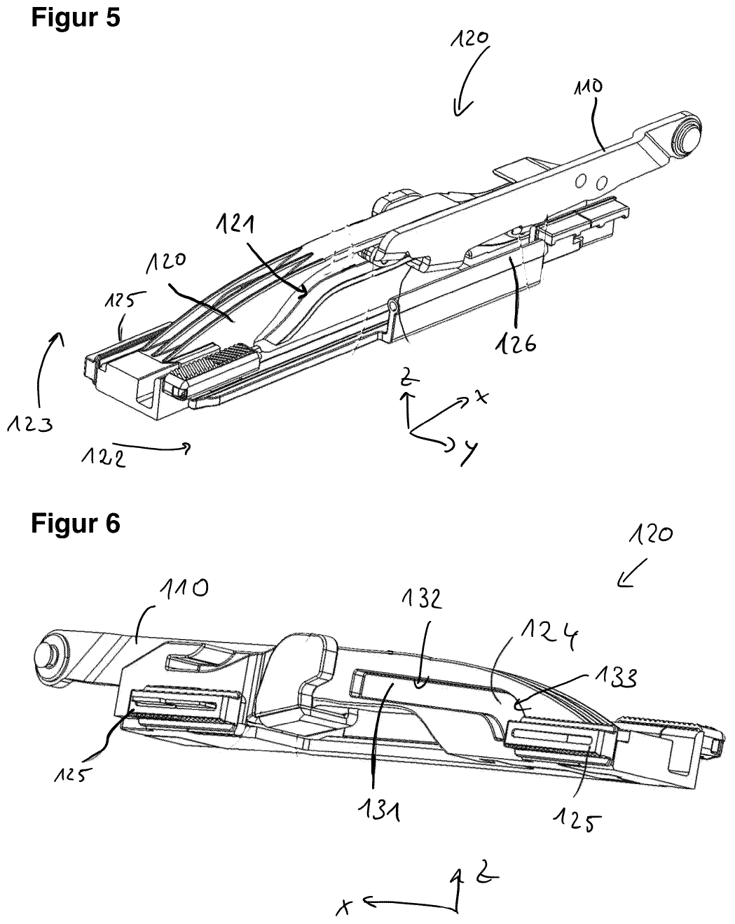

FIGS. 5 and 6 show the carriage 120 and the rear opening-out lever 110 according to one exemplary embodiment.

The carriage 120 has a longer extent along the longitudinal direction X than along the transverse direction Y and the vertical direction Z. The carriage 120 is guided in the guide rail 107 by means of carriage sliders 125. For example, carriage sliders 125 are arranged at a front end of the carriage 120 and at a rear end of the carriage 120.

The carriage 120 has a control track 131. The control track 131 serves to couple the carriage 120 to the control rod 150.

The carriage 120 has an opening-out track 121. The opening-out track 121 serves to couple the carriage 120 to the rear opening-out lever 110. The opening-out track 121 has a profile which, as seen along the longitudinal direction X, first of all is inclined, then runs rectilinearly with no inclination and subsequently is inclined again. This makes it possible to control the movement of the rear opening-out lever 110; this movement will not be discussed in any more detail.

The opening-out track 121 is arranged on a first side 122 of the carriage. The control track 131 is arranged on an opposite, second side 123 of the carriage. The two sides 122, 123 are arranged opposite one another along the transverse direction Y and extend essentially parallel to the XZ plane. A separating wall 124 of the carriage 120 is formed between the control track 131 and the opening-out track 121.

The carriage 120 is therefore designed so that, on the one side 122, it comes into engagement with the opening-out lever 110 and, on the opposite side 123, it comes into engagement with the control rod 150.

Displacement of the carriage 120 relative to the guide rail 107 can therefore bring about both movement of the rear opening-out lever 110 and movement of the control rod 150. The carriage 120 has a cable connection 126. The carriage 120 can be connected to a drive cable by means of the cable connection 126, so that drive power of an electric motor can be transmitted to the carriage 120.

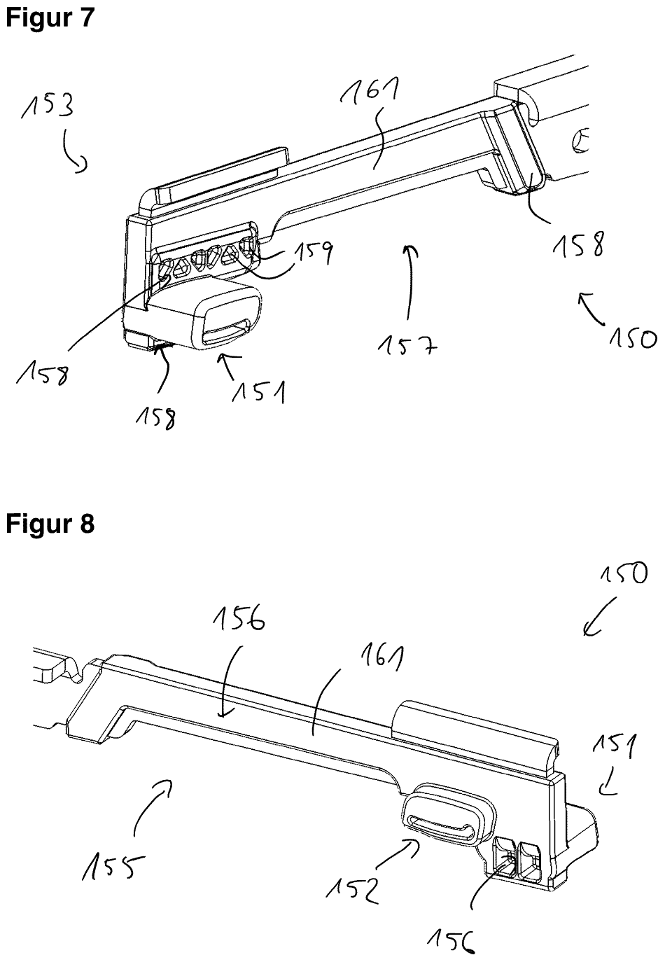

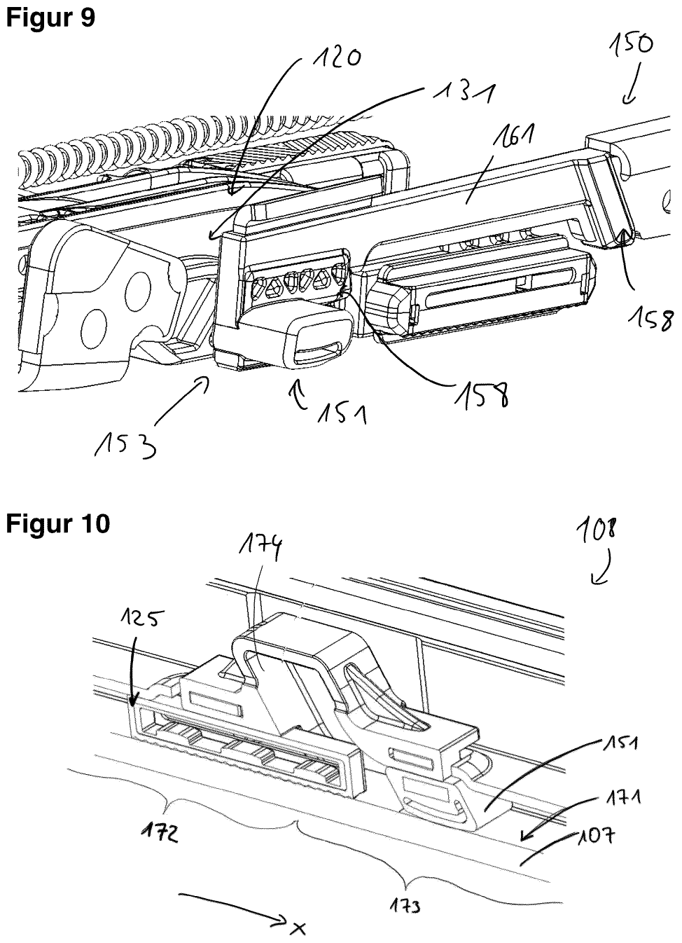

As can be gathered for example from FIGS. 7 to 9, the control rod 150 has a control slider 151 and a protrusion 152 at the first end 153. The control slider 151 and the protrusion 152 protrude along the Y direction, albeit in opposite directions.

The protrusion 152 is designed to engage in the control track 131 of the carriage 120. By means of the protrusion 152 engaging in the control track 131, the first end 153 of the control rod 150 is movable along the vertical direction Z. The control rod 150 is therefore movable between a first state and a second state. In the first state, the control rods 150 is locked for example relative to the guide rail 107 along the longitudinal direction X. In the second state, the control rod 150 is displaceable, in particular together with the carriage 120, for example relative to the guide rail 107 along the longitudinal direction X. The displacement is brought about in particular by the protrusion 152 being coupled in the control track 131. It is therefore possible for a drive movement of the carriage 120 to be transmitted to the front opening-out lever 109 by means of the control rod 150.

The control track 131 has an essentially rectilinear first profile portion 132 (see FIG. 6). When the protrusion 152 is arranged in the first profile portion 132, the carriage 120 is displaceable relative to the control rod 150 along the longitudinal direction X. In other words, if the carriage 120 is displaced in the longitudinal direction X, then the control rod 150 is not moved in the longitudinal direction X.

The control track 131 has a second profile portion 133, which runs essentially along the vertical direction Z. When the protrusion 152 is arranged in this region, as a result of the carriage 120 being displaced relative to the control rod 150, the carriage 120 is coupled to the control rod 150 and movement of the carriage 120 relative to the guide rail 107 along the longitudinal direction X is transmitted to the control rod 150.

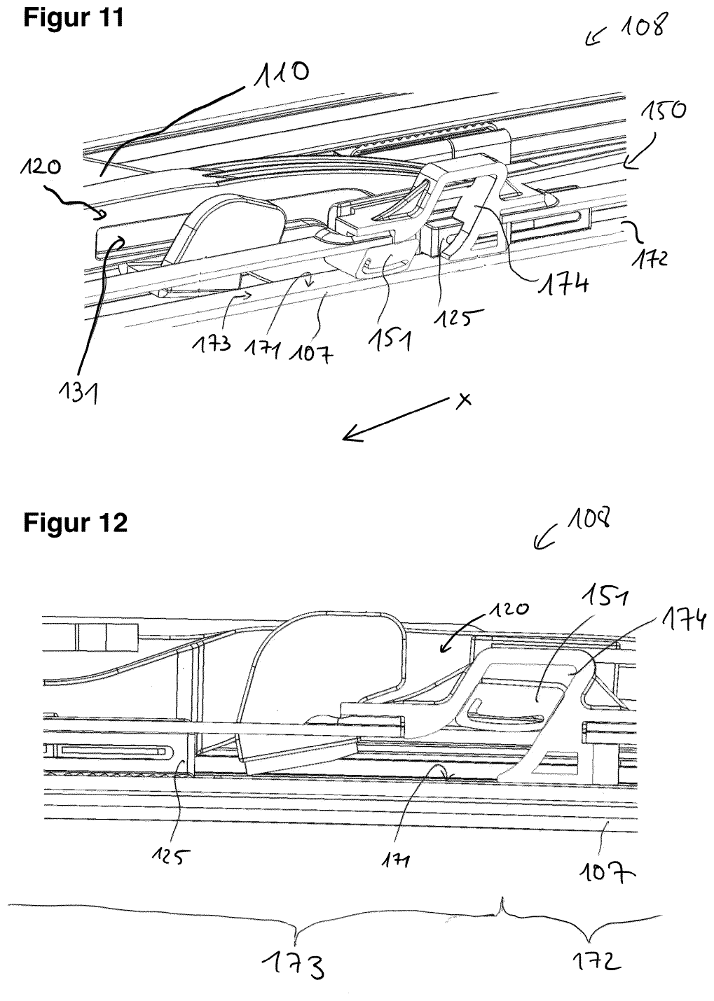

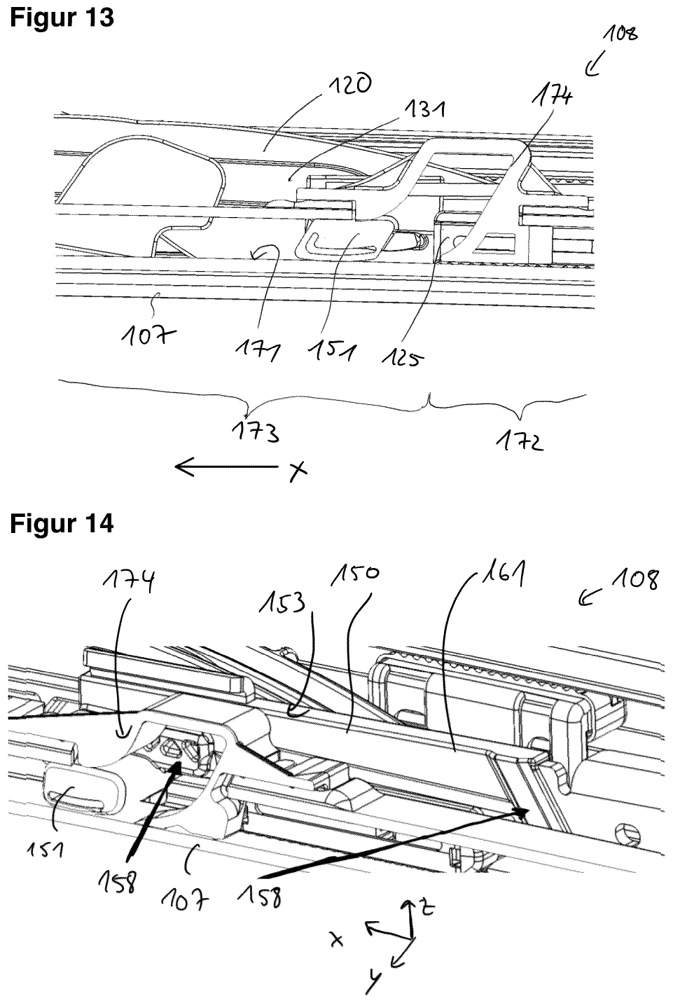

As can be gathered with reference to FIGS. 10 to 14, the control slider 151 interacts with a locking track 174 of the guide rail 107.

The guide rail 107 has a guide path 171 for the carriage sliders 125. The guide path 171 runs essentially along the longitudinal direction X.

The locking track 174 runs in an inclined manner in relation to the guide path 171 essentially along the vertical direction Z. The locking track 174 runs in an upwardly inclined manner beginning from the guide path 171.

When the control slider 151 is arranged in the locking track 174, in particular on an upper region of the locking track 174, the control rod 150 is locked along the longitudinal direction X relative to the guide rail 107 (FIG. 12).

By means of the protrusion 152 engaging in the control track 131, it is possible to drive movement of the control slider 151 along the locking track 174 when the carriage 120 is being displaced. It is thus possible for example for the control slider 151 to be introduced into the locking track 174 or uncoupled from the same.

When the control slider 151 has been guided out of the locking track 174 and is arranged in the guide path 171, it is possible for the control rod 150 to be displaced along the longitudinal direction X relative to the guide rail 107. In this state, the carriage 120 and the control rod 150 are locked to one another such that relative movement along the longitudinal direction X between the carriage 120 and the control rod 150 is blocked.

The guide path 171 has for example a first portion 172 and a second portion 173. The first portion 172 is arranged in a front region, as seen along the longitudinal direction X. The second portion 173 is arranged in a rear region, as seen along the longitudinal direction X. Only the carriage slider 125 is guided in the first portion 172. The control slider 151 is not guided in the first portion 172. Both the control slider 151 and the carriage slider 125 are guided in the second portion 173. In the second portion 173, the control slider 151 and the carriage slider 125 run together in the guide path 171.

FIGS. 10, 11 and 13 show that the control slider 151 has been guided out of the locking track 174, this therefore freeing the movement of the control rod 150 in the X direction. The control rod 150 is thus in an unlocking position. FIG. 12, in contrast, shows the locking position of the control rod 150, in which the control slider 151 is locked in the locking track 174, that is to say movement in the X direction is blocked.

An opening operation of the vehicle roof 101 takes place as follows. Starting from the closed position shown in FIG. 2, the carriage 120 is displaced rearwards. The rear opening-out lever 110 is actuated, that is to say opened out or deployed. The cover 103 is thus raised in the Z direction at the rear edge 106 and transferred into the ventilation position. In this movement phase, the carriage 120 is movable relative to the control rod 150, since this movement is freed by the control track 131. The control rod 150 is locked in the X direction by means of the locking track 174. If the carriage 120, then, is displaced further rearwards, the control rod 150 is unlocked, by the control slider 151 being guided out of the locking track 174. At the same time, the control rod 150 is fixed to the carriage 120 via the control track 131, so that movement of the carriage 120 causes the control rod 150 to be moved along in the X direction. By virtue of the control rod 150 being coupled to the front opening-out lever 109, the cover support 111, and therefore also the cover 103, is displaced in the X direction into a maximum-opening position, in which the roof opening 102 is open to the maximum extent. The movement sequence takes place in reverse order for the purpose of closing the roof opening 102.

Details of the control rod 150 according to one exemplary embodiment of the invention will be discussed in the following text.

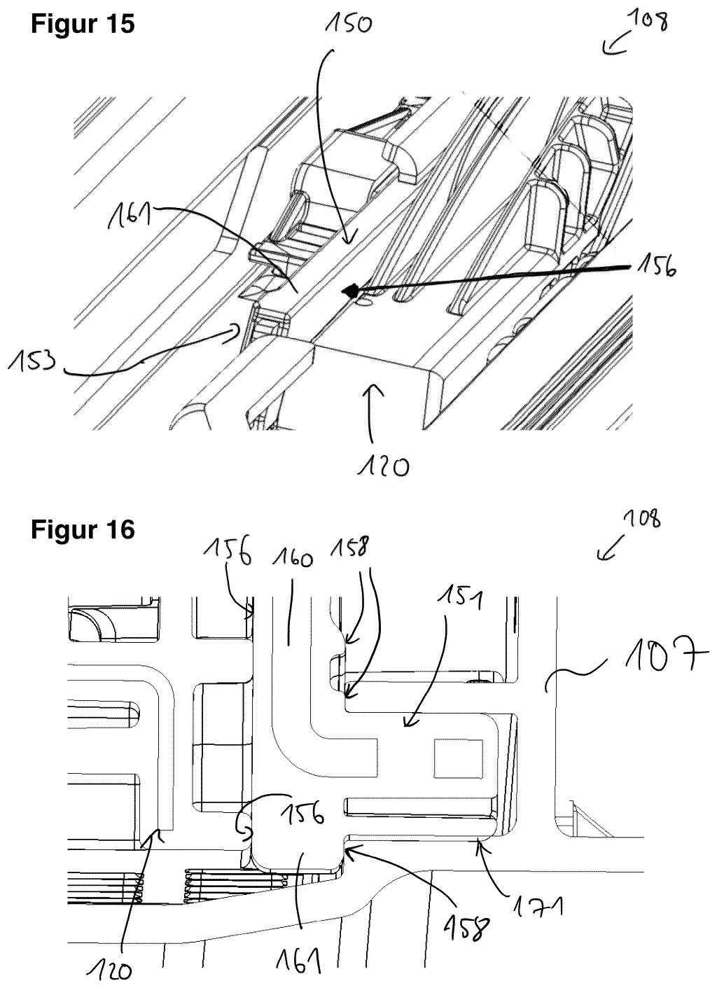

In the exemplary embodiment, the control rod 150 is guided on both sides, as seen in relation to the transverse direction Y, as is evident in particular with reference to FIGS. 15 and 16. In particular, the control rod 150 is supported in the region of the rear end 153 both in relation to the guide rail 107 and the carriage 120. The support is, in particular, such that the control rod 150 can slide both on the guide rail 107 (including the locking track 174, which is an integral constituent part of the guide rail 107) and on the carriage 120, depending on the movement phase as described above. The control rod 150 is guided in particular in a form-fitting manner, as described in the introduction, between the guide rail 107 and carriage 120. In each movement phase, the control rod 150 is supported on both sides on the guide rail 107 and carriage 120.

Looking at FIGS. 7 to 9, on a first side 155, which is directed towards the carriage 120, the control rod 150 has one or more first sliding surfaces 156 for guiding on the carriage 120. On a second side 157, which is directed towards the guide rail 107, the control rod 150 has one or more second sliding surfaces 158 for guiding on the guide rail 107. As an option, it is possible for a sliding surface 156, 158 to have recesses 159, as shown in FIG. 7 for the left-hand sliding surface 158.

FIG. 16 shows a schematic sectional view (in the XZ plane) through the opening-out mechanism 108, the section being taken through the carriage 120, the control rod 150 at the rear end 153, and the guide rail 107. It is possible to see the control slider 151 in the guide path 171. It is also possible to see how the control rod 150 is supported both via the sliding surfaces 156 on the carriage 120 and via the sliding surfaces 158 on the guide rail 107.

It can additionally be seen with reference to FIG. 16 that the control rod 150, in particular in the region of the rear end 153, is designed in the form of a metallic reinforcing element 160 with a plastic over-moulding 161. In other words, the sliding surfaces 156, 158 are part of the plastic over-moulding 161 or are formed thereon.

It is noted here that the carriage 120, the opening-out levers 109, 110 and the guide rail 107, although presented herein as advantageous, can also be otherwise designed. The critical factor is for the control rod 150 to be supported, as described, between the carriage 120 and guide rail 107.

### LIST OF REFERENCE SIGNS

100 vehicle
101 vehicle roof
102 roof opening
103 cover
104 windscreen
105 front edge
106 rear edge
107 guide rail
108 opening-out mechanism
109 front opening-out lever
110 rear opening-out lever
111 cover support
120 carriage
121 opening-out track
122 first side
123 second side
124 separating wall
125 carriage slider
126 cable connection
131 control track
132 first profile portion
133 second profile portion
150 control rod (control lever)
151 control slider
152 protrusion
153 rear end
154 front end
155 first side
156 first sliding surfaces
157 second side
158 second sliding surfaces
159 recess
160 reinforcing element
161 plastic over-moulding
171 guide path
172 first portion
173 second portion
174 locking track

1. An arrangement for moving a cover for a vehicle roof which has a roof opening, wherein, for opening purposes-starting from a closed position, in which the cover closes the roof opening—an opening-out mechanism can be used to open out the cover, in the region of its rear edge, into a ventilation position and then to bring it into an open position, wherein the opening-out mechanism has:
a guide rail, which extends longitudinally along a longitudinal direction,
a carriage, which can be displaced along the longitudinal direction in the guide rail, wherein the carriage is coupled to the cover for the purpose of moving the latter,
wherein
the opening-out mechanism has a movable control lever for controlling the movement of the cover, and
as seen in relation to a transverse direction, which runs transversely to the longitudinal direction, the movable control lever is supported on the carriage and the guide rail such that it is guided both in a displaceable manner on the carriage and in a displaceable manner on the guide rail.

2. The arrangement according to claim 1, wherein, as seen in relation to the transverse direction, the control lever is guided in a form-fitting manner between the guide rail and the carriage.

3. The arrangement according to claim 1, wherein, in each movement phase of the cover, the control lever is supported both on the guide rail and on the carriage.

4. The arrangement according to claim 1, wherein on a first side, which is directed towards the carriage the control lever has one or more sliding surfaces for guiding on the carriage, and wherein on a second side, which is directed towards the guide rail, the control lever has one or more sliding surfaces for guiding on the guide rail.

5. The arrangement according to claim 4, wherein at least one sliding surface has one or more recesses.

6. The arrangement according to claim 1, wherein, in the region of a rear end of the control lever, the control lever is supported on the carriage and the guide rail.

7. The arrangement according to claim 1, wherein the control lever has a reinforcing element, which is provided with a plastic over-moulding for support on the carriage and on the guide rail.

8. The arrangement according to claim 1, wherein the control lever is designed in the form of a control rod and is coupled to the carriage for the purpose of controlling the cover.

9. The arrangement according to claim 1, wherein the guide rail has a guide path for guiding the carriage and the control lever.

10. The arrangement according to claim 1, wherein the carriage has a control track and the control lever has a protrusion, by means of which the control lever is in engagement with the control track, wherein the control track is designed such that, in the closed position of the cover, there is free relative movement between the control lever and the carriage in the longitudinal direction and—starting from the closed position of the cover—when the carriage is displaced along the longitudinal direction, the protrusion can be brought into engagement with the control track such that relative movement between the control lever and the carriage is arrested.

11. The arrangement according to claim 1, wherein the guide rail has a fixed-position locking track for the control lever, wherein the control lever has a control slider for engaging in the locking track, wherein the locking track is designed such that, in the closed position of the cover, the control lever is located in a locking position, so that movement of the cover along the longitudinal vehicle direction is blocked, and—starting from the closed position—when the carriage is displaced along the longitudinal direction, the control lever can be directed, by means of a rear opening-out lever, out of the locking position into an unlocking position, so as to free movement of the cover along the longitudinal direction.

12. The arrangement according to claim 1, having a front opening-out lever and a rear opening-out lever, wherein the rear opening-out lever is in engagement with the carriage, so that, when the carriage is being displaced, it is possible to control an opening-out movement of the cover into the ventilation position, and wherein the control lever is coupled both to the front opening-out lever and to the carriage.

13. A vehicle roof for a vehicle, having an arrangement according to claim 1.
